(19) United States
(12) Patent Application Publication
(10) Pub. No.: US 2026/0167467 A1
(43) Pub. Date: Jun. 18, 2026

(54) DEFLECTION DEVICE FOR A CABLE COMPRISING A CABLE SECURING ELEMENT, AND LIFTING DEVICE THEREWITH

(71) Applicant: Liebherr-Werk Ehingen GmbH, Ehingen (DE)

(72) Inventors: Linda KLÖBLE, Dächingen (DE); Julian SPRANZ, Munderkingen (DE)

(21) Appl. No.: 19/423,185

(22) Filed: Dec. 17, 2025

(30) Foreign Application Priority Data
Dec. 17, 2024 (DE) 10 2024 138 427.1

(51) Int. Cl. B66D 3/04; B66C 15/00; B66C 23/36

(52) U.S. Cl. CPC B66D 3/04; B66C 15/00; B66C 23/36

(57) ABSTRACT

The disclosure relates to a deflection device for a cable, comprising a pulley mounting for carrying at least one cable deflection pulley, at least one cable deflection pulley, which is mounted on the pulley mounting so as to be rotatable about a pulley rotational axis, and a cable securing arrangement for securing a correct reeving of a cable on the cable deflection pulley, characterised in that the cable securing arrangement is pivotable relative to the pulley mounting about a pivot axis, in order to switch between a securing position, in which a cable deflected by the cable deflection pulley is secured in the cable deflection pulley, and a release position, in which a cable deflected by the cable deflection pulley is not secured in the cable deflection pulley, wherein the pivot axis extends in parallel with the pulley rotational axis.

### CROSS REFERENCE TO RELATED APPLICATION

The present application claims priority to German Patent Application No. 10 2024 138 427.1 filed on Dec. 17, 2024. The entire contents of the above-listed application are hereby incorporated by reference for all purposes.

### TECHNICAL FIELD

The present disclosure relates to a deflection device for deflecting a cable, and a system and a lifting device comprising such.

### BACKGROUND

A plurality of lifting devices or work machines comprise cables, which are deflected via at least one deflection pulley on the machine, for example a lifting cable, which is reeved multiple times between deflection pulleys of a boom head and a hook block. The deflection pulleys are frequently secured by safety devices, which ensure that the cable does not spring out of the deflection pulleys. An example for such safety devices are so-called cable protection bars, as are frequently used in wheeled cranes or mobile cranes. These cable protection bars are arranged at a small radial spacing from the deflection pulleys, such that they do not touch the deflection pulleys or the cable, but prevent the cable from springing out of the deflection pulleys.

### SUMMARY

During reeving of the cable, it is repeatedly the case, in such devices, that the cable is not threaded in between the cable protection bar and deflection pulleys, but rather is incorrectly guided on the outside, over the cable protection bar. This can result in significant material damage on the cable.

The object of the present disclosure is therefore that of reducing or even entirely preventing the risk of such incorrect reeving in deflection devices of the type in question. Furthermore, it should be noted at this point that when reference is made, in the following, to “the deflection pulley” in the singular, the at least one deflection pulley is also always meant.

According to the disclosure, this object is achieved by a deflection device, a system, and a lifting device having the features described herein.

According thereto, according to the disclosure a deflection device for a cable, such as a lifting cable of a crane, is proposed, which comprises a pulley mounting for carrying at least one cable deflection pulley, at least one cable deflection pulley, which is mounted on the pulley mounting so as to be rotatable about a pulley rotational axis, and a cable securing arrangement for securing a correct reeving of a cable on the cable deflection pulley. The device is characterised in that the cable securing arrangement is pivotable relative to the pulley mounting about a pivot axis, in order to switch between a securing position, in which a cable deflected by the cable deflection pulley is secured in the cable deflection pulley, and a release position, in which a cable deflected by the cable deflection pulley is not secured in the cable deflection pulley, wherein the pivot axis extends in parallel with the pulley rotational axis.

The deflection device according to the disclosure makes it possible to switch the cable securing arrangement between the release position and the securing position relatively quickly and intuitively. Ultimately, all that is required for this is the transfer between the positions by means of a pivot movement, which is roughly guided by the outer periphery of the deflection pulley, wherein typically the radial spacing of the securing arrangement with respect to the deflection pulley increases upon transfer from the securing position into the release position.

The parallelism of the pivot axis with respect to the pulley rotational axis furthermore ensures precise and stable positioning of the cable securing arrangement, which leads to an increase in the operating reliability and the service life of the cable deflection pulleys.

According to an optional modification of the present disclosure, it can be provided that the cable securing arrangement comprises at least one cable protection bar, which is configured, in the securing position of the cable securing arrangement, to limit a movement of the cable, guided by the cable deflection pulley, in the radial direction away from the cable deflection pulley, optionally wherein the at least one cable protection bar is oriented having its longitudinal axis in parallel with the pulley rotational axis, and/or is mounted so as to be rotatable about its longitudinal axis.

Accordingly, the cable protection bar serves to secure a cable, correctly reeved in the deflection pulley, in the deflection pulley, such that undesired springing out of the cable in a load-free state is prevented. Typically, this takes place by bringing the cable protection bar close to the outer periphery of the deflection pulley, such that the spacing between the cable protection bar and a radially outer region of the deflection pulley is smaller than the cable thickness of the cable deflected by the deflection pulley.

Since the cable protection bar is oriented in parallel with the pulley rotational axis of the at least one deflection pulley, a particularly simple and robust cable securing arrangement is formed with the aid of the pivot movement that leads to the transfer from a securing position into the release position. Since, in the case of a cable guided by the deflection pulley seeking to spring out, the cable protection bar serves to hold said cable in position in its respective deflection pulley, it is helpful, for reducing friction between the cable protection bar and a cable, if the cable protection bar itself is mounted so as to be rotatable about its longitudinal axis. If contact then occurs between the cable to be secured and the cable protection bar, the friction arising in the process leads to a rotation of the cable protection bar, which prevents excessive friction arising, which would occur if the cable protection bar were not rotatable.

It can advantageously be provided, according to a further development of the present disclosure, that the at least one cable protection bar assumes a greater radial spacing from the at least one cable deflection pulley in a release position than in the securing position, in order to allow for correct reeving of a cable on the at least one cable deflection pulley, in which the cable to be reeved is arranged between the at least one cable deflection pulley and the at least one cable protection bar.

In a release position, the cable protection bar is arranged radially further away from the outer peripheral surface of the cable deflection pulley, in order to allow for reeving of a cable in the cable deflection pulley. In the securing position, in which the radial spacing from the outer peripheral surface of the cable deflection pulley is smaller, the cable start of the cable to be deflected by the cable deflection pulley cannot be correctly reeved, owing to its typically increased diameter compared with the cable diameter. In the case, the cable start of the cable is generally provided with a spelter socket, which serves for holding together the individual fibres or strands of the cable. This closure spelter socket is larger in diameter than the cable diameter, such that correct reeving into the cable deflection pulley is not possible in the case of a cable securing arrangement in the securing position.

It is optionally provided, here, that the at least one cable protection bar is radially further removed from the at least one cable deflection pulley, in the release position and when the deflection device is oriented as intended, than a reeving curve of a cable to be reeved, for example a steel cable, the dimensioning of which is matched to the at least one cable deflection pulley.

In this case, the reeving curve describes an expression known to a person skilled in the art, and refers to the specific route or the path along which a cable, such as a lifting cable of a crane, extends during the reeving process along the cable deflection pulleys.

In this case, it can optionally be provided that the reeving curve is set to one side by a horizontal feed from the other side onto an upper point of a cable deflection pulley, and the cable start guided over the upper point of the cable deflection pulley is observed by further feeding of cable length.

According to a further optional modification of the present disclosure, it can be provided that the pivot axis is arranged, relative to the pulley rotational axis, so as to be radially offset with respect to the at least one cable deflection pulley.

The radial offset of the pivot axis relative to the pulley rotational axis for example achieves the desired effect, in the case of pivoting of the cable securing arrangement, according to which the radial spacing in the securing position of the cable securing arrangement is smaller, relative to the outer periphery of the at least one cable deflection pulley, than in the release position.

It can furthermore be provided, according to the present disclosure, that the cable securing arrangement comprises two limb elements, which are rotatably fastened on opposing side parts of a receiving space of the pulley mounting for receiving the at least one cable deflection pulley, for example in such a way that the rotatable fastening of the two limb elements represents the pivot axis of the cable securing arrangement, optionally wherein two limb elements are configured identically to one another.

Accordingly, it can therefore be provided that the cable securing arrangement comprises two limb elements, each of which is rotatably fastened at one side part of the pulley mounting. In this case, the rotatable fastening of a respective limb element is typically arranged in the pivot axis, such that pivoting of the two limb elements results in the cable securing arrangement being able to switch between the release position and the securing position.

In this case, each of the two limb elements is arranged on a side part of a receiving space of the pulley mounting, wherein such a side part is arranged so as to be offset, in the direction of the pulley rotational axis, relative to the at least one cable deflection pulley received in the receiving space, and typically serves for mounting the at least one cable deflection pulley received in the receiving space. In this case, the fastening of a first limb element takes place on a first side part, whereas the fastening of a second limb element takes place on the side part opposite the first side part, which is arranged so as to be offset in the direction of the pulley rotational axis. Accordingly, the two inside surfaces of the side parts of the pulley mounting face the different planar sides of the at least one cable deflection pulley. It is clear to a person skilled in the art that the two limb elements do not necessarily have to be arranged on an inner side of the two side parts, but rather other surfaces of the side parts are also available for this. For example, it is provided that the two limb elements are rotatably fastened to an element that protrudes forwards from the side part, wherein the protruding element is in this case located in a plane that is in parallel with a plane defined by the cable deflection pulley.

The receiving space is typically adjusted to the exact number of the individual or plurality of cable deflection pulleys, such that the width of the receiving space substantially corresponds to the width of the plurality of cable deflection pulleys arranged side-by-side. However, a person skilled in the art knows that not all cable pulleys have to be in use, i.e. are reeved.

According to a further advantageous embodiment of the present disclosure, it can be provided that the at least one cable protection bar is mounted, for example rotatably mounted, at its respective longitudinal end regions on the two limb elements, and is oriented in parallel with the pulley rotational axis.

Accordingly, the mounting of the cable protection bar takes place on the limb elements that are spaced apart from one another along the pulley rotational axis, such that a longitudinal end or a longitudinal end region of the cable protection bar is mounted on a first limb element, and the other longitudinal end or the other longitudinal end region is mounted on a second limb element, wherein for example an opening is provided in a respective one of the two limb elements, for mounting, such that the cable protection bar can be rotatably received in the respective opening. In this case, securing of the cable protection bar that prevents the cable protection bar from leaving the desired position in the respective opening of a limb element can take place by inserting a securing pin, which crosses the diameter of the cable protection bar, such that a movement of the cable protection bar in the direction of the pulley rotational axis is not possible or is possible only to a very limited extent. In this case, it can also be provided that the cable protection bar mounted by the two limb elements has such an opening, for pushing in a securing pin, in each of its two longitudinal end regions, such that the cable protection bar is fixed in the direction of the pulley rotational axis by the provision of the two securing pins.

It can furthermore be provided, in this case, that a blocking element extends between the two limb elements, in the direction of the pulley rotational axis, which blocking element serves to make it more difficult to guide through a cable, deflected by the deflection pulley, on a side facing away from the cable securing arrangement to the at least one deflection pulley, for example in such a way that an opening region between the blocking element and a cable protection bar does not allow for a cable, or its cable spelter socket located at the cable start thereof, the dimensions of which cable are matched to the at least one cable deflection pulley, to be guided through.

In this case, the blocking element can be configured in a plate-like or tubular manner, and extends from one limb element to the other limb element.

Providing the blocking element means that it is no longer possible to so easily overlook an incorrectly reeved cable, since the incorrectly reeved cable now no longer only spans the cable protection bar on the side facing away from the cable deflection pulley, but rather also the blocking element, and is thus significantly easier to identify. Finally, then not only the cable protection bar, but rather also the blocking element, at the side thereof facing away from the deflection pulley, is encompassed by the incorrectly reeved cable. However, incorrect reeving of this kind is significantly more unlikely according to the present disclosure, since unintentional incorrect reeving is excluded de facto. However, if, in advertently or for other reasons, the cable to be reeved is tensioned on the side of the cable protection bar facing away from the cable deflection pulley, even in the case of a deflection device according to the present disclosure, such a state would be significantly easier to identify visually.

According to a further embodiment of the present disclosure, it can be provided that a grip element, for example a rod-like grip element, extends between the two limb elements, in parallel with the pulley rotational axis, which allows for simple hand-actuated pivoting of the cable securing arrangement between the release position and the securing position.

In order to transfer the cable securing arrangement from the securing position into the release position, and vice versa, it is helpful to provide a grip element, such that the switch between the two positions can be carried out by hand, in a simple manner. In order to be able to exert a force on the cable securing arrangement in the process, which force approximately corresponds to the pivot movement to be performed for switching the positions, it is advantageous if a grip element extends between the two limb elements, such that a force can be exerted on the two limb elements simultaneously, with the aid of the grip element.

According to a further optional development of the present disclosure, it can be provided that the deflection device further comprises at least one locking device for locking the cable securing arrangement in the securing position and/or the release position, on the pulley holder.

A locking device of this kind serves for locking the cable securing arrangement in the release position and/or the securing position. This is advantageous in particular because it is undesirable for the cable securing arrangement to leave the release position and/or the securing position unnoticed. Ultimately, the situation could then arise that, in the event of the cable securing arrangement leaving its securing position, a cable guided by the cable deflection pulley can no longer be prevented from springing out. Furthermore, it would be likewise undesirable for the cable securing arrangement to leave the release position unnoticed, since this would significantly disturb the usual course of a reeving process or a swinging out process. Under some circumstances, it would then also no longer be ensured that the cable protection bar is also actually located outside a reeving curve, such that there could possibly be an undesired collision of the cable to be reeved with the cable securing arrangement or, at worst, an unintended spanning of the cable securing arrangement, such that the cable to be reeved is tensioned over the side of the cable protection bar facing away from the cable deflection pulley.

It is therefore advantageous, for the reasons mentioned above, if a reliable positioning can be assumed by the cable securing arrangement in the release position and/or the securing position.

According to a further advantageous development of the present disclosure, it can be provided that the at least one locking device comprises a detent opening and an associated detent, wherein in each case one component of the locking device is arranged on the cable securing arrangement and the other component is arranged on the pulley mounting, optionally wherein the at least one locking device comprises a preloaded latching pin as the detent, an associated latching hole as the detent opening, and furthermore a deflection element, such that upon transfer of the cable securing arrangement into the securing position and/or the release position, the deflection element deflects the latching pin counter to its preloaded position, and after the securing position and/or the release position has been reached the preloaded latching pin latches into the detent opening which is then flush with the latching pin.

For example an element curved towards a central region of the receiving space is possible as the deflection element, which element pushes a detent element, preloaded by means of tensioning element, counter to the preloading direction, when the pivot movement for transfer into the release position and/or the securing position is performed, such that latching into an opening, a step-like chamfer or the like is made possible after the desired position has finally been reached.

Release out of the position, once assumed in this way, is then only possible in that the detent element, preloaded with the tensioning element, is moved counter to its spring force, such that the detent element is no longer in latching engagement with the latching partner and the cable securing arrangement can be moved along the pivot movement again.

According to a further optional modification of the present disclosure, it can be provided that, in the securing position, the locking device comprises the cable protection bar and receiving openings for the cable protection bar, arranged on opposing side parts of a receiving space of the pulley mounting, such that the securing position can be left only after the cable protection bar has been released from the receiving openings.

According to this embodiment, the cable protection bar is part of the locking device, such that a movement of the cable securing arrangement out of the release position and/or the securing position is only possible in that the cable protection bar has been removed from corresponding openings which are rigidly connected to the side parts of the pulley mounting. It can furthermore be provided, in this case, that each of the two limb elements, as also the openings proceeding from or formed in the two side parts, are oriented so as to be flush with one another in the release position and/or the securing position, such that locking of the cable securing arrangement takes place by inserting the cable protection bar into the mutually flush openings of the limb elements and the openings proceeding from or formed in the side parts.

According to a further optional modification of the present disclosure, it can be provided that at least two cable protection bars are provided, which act on different radial regions of the at least one cable deflection pulley and the respective active regions of the two cable protection bars in the peripheral direction of the cable deflection pulley enclose an angle relative to one another that exceeds 60°, optionally 75° or 90°.

In order to ensure that a cable deflected by a cable deflection pulley remains in its intended guide along a large peripheral region of the cable deflection pulley, it is advantageous if a plurality of cable protection bars are provided, which are arranged so as to be spaced apart from one another in the peripheral direction of the cable deflection pulley. This causes it to be ensured, at two points spaced apart in the peripheral direction of the cable deflection pulley, that the cable remains in the guide of the cable deflection pulley. This makes it possible to ensure, over a large peripheral region of the cable deflection pulley, that the cable is guided in the provided guide of the cable deflection pulley.

In this case it can be provided, in a further optional modification, that each of the two cable protection bars extends between the two limb elements, and/or the two cable protection bars are oriented in parallel with one another.

The disclosure furthermore relates to a system comprising a deflection device according to any of the aspects discussed above and a cable, wherein the dimensioning of the cable, for example its diameter, is matched to the at least one cable deflection pulley and is deflected thereby, wherein the cable is optionally a steel cable.

The present disclosure further relates to a work machine or a lifting device, such as a crane or mobile crane, comprising a deflection device according to any of the aspects discussed above or a system according to the preceding paragraph.

It can advantageously be provided here that the deflection device is arranged on a boom head of a boom, for example of a telescopic boom, and optionally serves for forming a cable connection to a hook block held by the boom.

### BRIEF DESCRIPTION OF THE FIGURES

Further features, details and advantages of the disclosure emerge from the embodiments which are explained below with reference to the figures, in which:

FIG. 1: is a side view of an embodiment of the work machine or lifting device according to the disclosure,

FIG. 2: is a front view of a boom head according to the prior art,

FIG. 3: is a side view of a deflection device according to the prior art together with a hook block attached to the deflection device,

FIG. 4A: is a perspective view of a cable securing arrangement according to the disclosure, according to a first embodiment,

FIG. 4B: is a side view of the deflection device according to the disclosure, according to the first embodiment, with the cable securing arrangement in the release position,

FIG. 4C: is a side view of the deflection device according to the disclosure, according to the first embodiment, with the cable securing arrangement in the securing position,

FIG. 4D: is a perspective view of the deflection device according to the first embodiment, with the cable securing arrangement in the securing position,

FIG. 5A: is a perspective view of a cable securing arrangement according to the disclosure, according to a second embodiment,

FIG. 5B: is a perspective view of a deflection device with the cable securing arrangement of the second embodiment in the release position,

FIG. 5C: is a perspective view of a deflection device with the cable securing arrangement of the second embodiment in the securing position,

FIG. 6A: is a perspective view of a cable securing arrangement according to the disclosure, according to a third embodiment,

FIG. 6B: is a perspective view of a deflection device with the cable securing arrangement of the third embodiment in the release position,

FIG. 6C: is a sectional side view of the deflection device with a cable securing arrangement of the third embodiment in the release position, in which the reeving curve of a cable is additionally inserted, and

FIG. 6D: is a perspective view of a deflection device with the cable securing arrangement of the third embodiment in the securing position.

### DETAILED DESCRIPTION

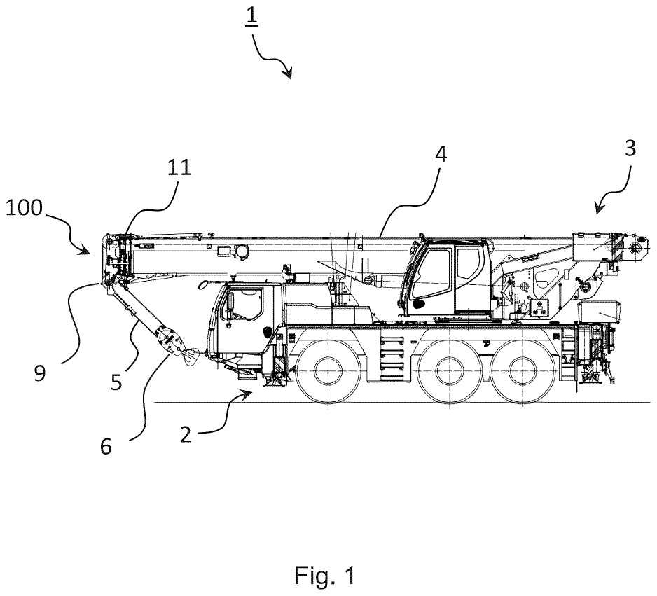

FIG. 1 shows an embodiment of the lifting device or work machine 1 according to the disclosure, in a side view. The work machine 1 of the embodiment shown is a mobile crane with a movable undercarriage 2, an upper structure 3 rotatably mounted on the undercarriage 2, and a telescopic boom 4 arranged on the upper structure 3, which boom has a boom head 11 at the end of the innermost telescopic section. A lifting cable 5 is guided from a lifting cable winch over a plurality of deflection pulleys on the boom head 11, and reeved between the deflection pulleys 9 and a hook block 6. The boom head 11 can comprise at least one deflection device 100 according to the disclosure, for deflecting the lifting cable 5. However, the present disclosure is not limited to this embodiment.

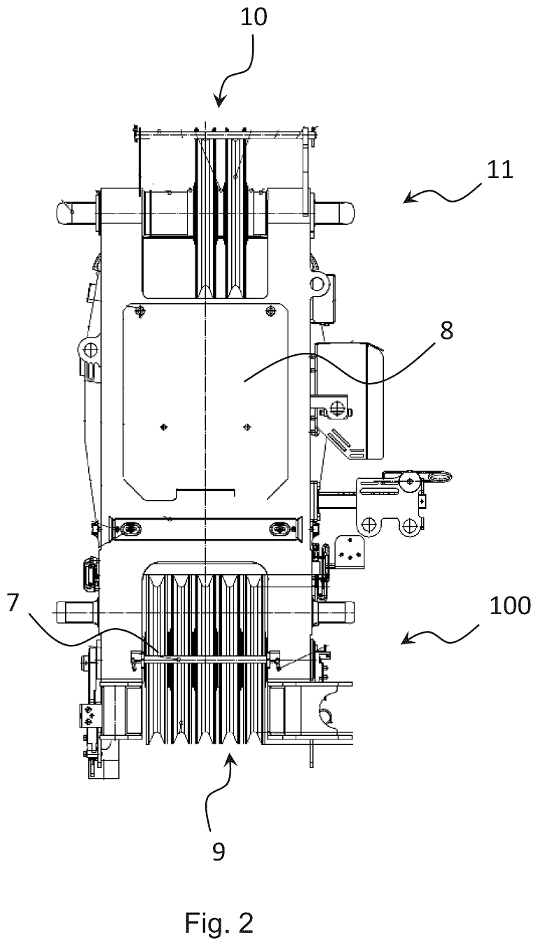

FIG. 2 shows an embodiment of a boom head 11 which comprises an upper pulley package consisting of cable deflection pulleys 10 and a lower pulley package consisting of cable deflection pulleys 9. According to the disclosure, it can be provided that each pulley package can be formed by a respective deflection device 100 according to the disclosure, in order to prevent springing out of the cable 5 for each pulley package, and to reliably prevent or more easily identify incorrect reeving. However, the disclosure also covers the situation where just one of the two pulley packages is formed by the deflection device 100 according to the disclosure.

In the case of a plurality of deflection pulleys 9 arranged side-by-side, as shown for example in FIG. 2, the cable securing arrangement 14 may extend over all the deflection pulleys 9 arranged side-by-side.

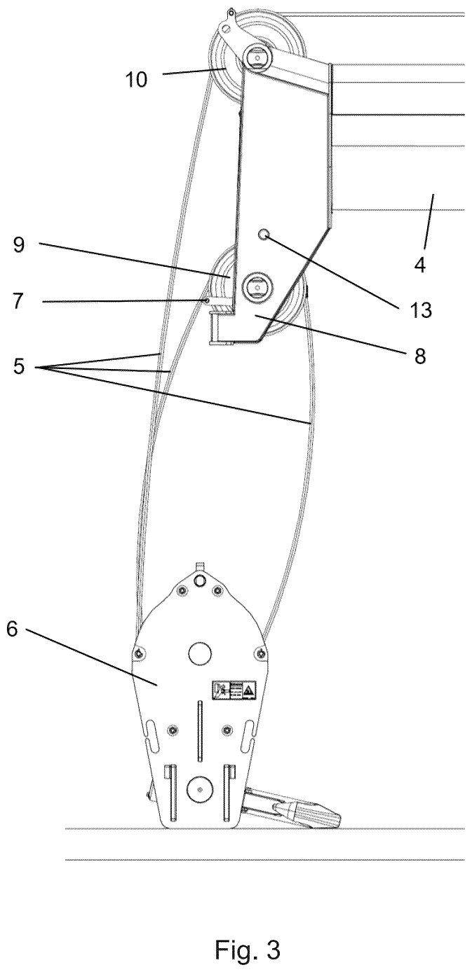

FIG. 3 is a side view of a deflection device according to the prior art, in which the telescopic boom 4 and the pulley head 8, arranged at its front end, are visible. The upper cable deflection pulleys 10, which form the upper pulley package, deflect the lifting cable 5 downwards, in the direction of the hook block 6. There, a deflection back to the pulley head 8 takes place, also with the aid of a cable deflection pulley (not visible in FIG. 3), such that the cable 5 can be reeved, there, with a cable deflection pulley 9 of the lower pulley package, before it is then guided back to the hook block 6 again. Depending on the number of cable deflection pulleys 9, a plurality of loops result between the pulley head 8 and the hook block 6.

In FIG. 3, it can be seen that when performing the reeving process the cable protection bar 7 was, incorrectly, not removed, which results in the cable 5, deflected by the cable deflection pulley 9, extending on the side of the cable protection bar 7 remote from the cable deflection pulley 9. A correct guidance of the cable 5 would have been one extending in the intermediate region between the cable deflection pulley 9 and the cable protection bar 7, since only then is it possible to prevent the cable 5 springing out of its guidance of the cable deflection pulley 9 in certain states. Furthermore, a second cable protection bar 13 is also visible, which is arranged in the upper region of the cable deflection pulley 9.

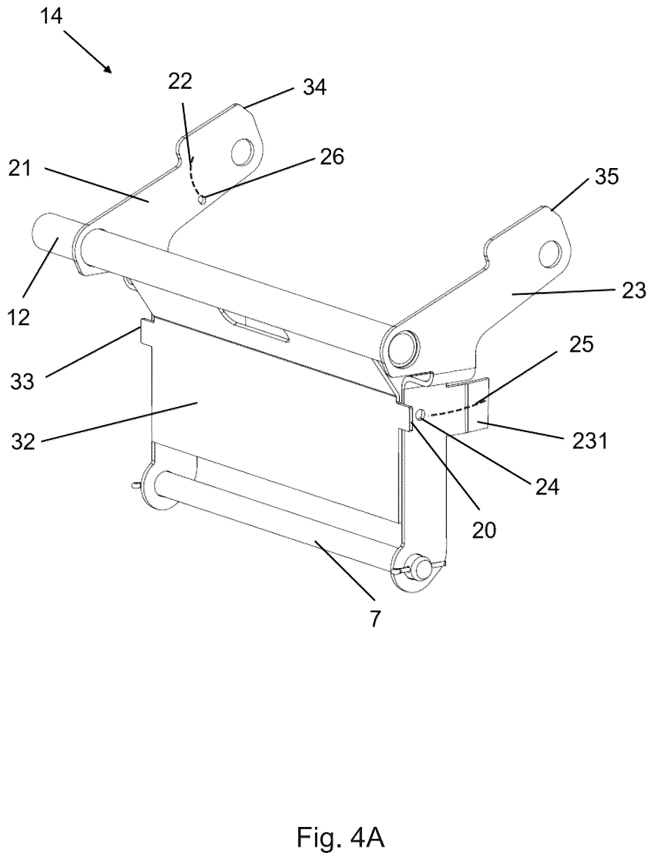

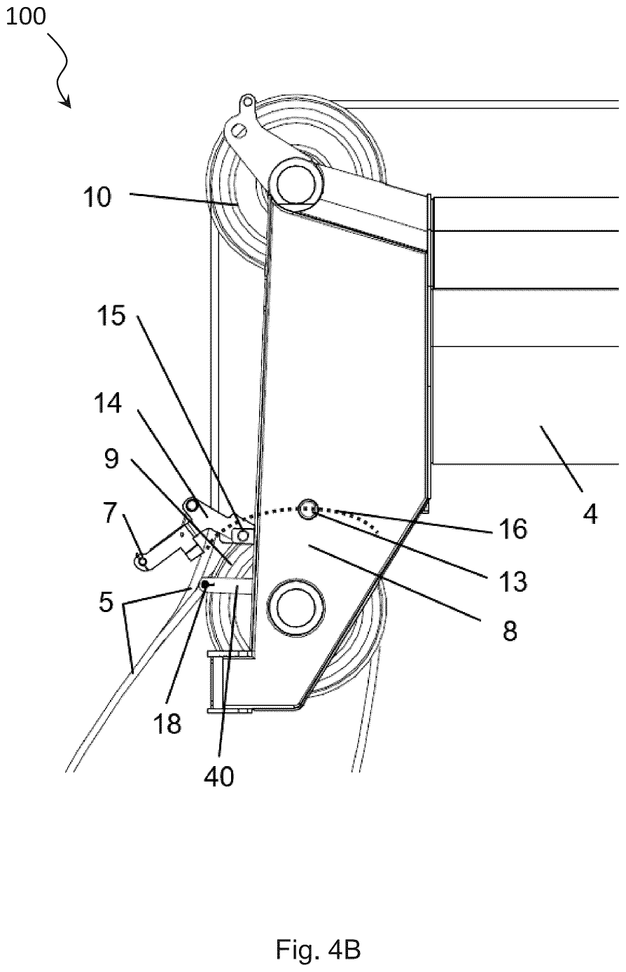

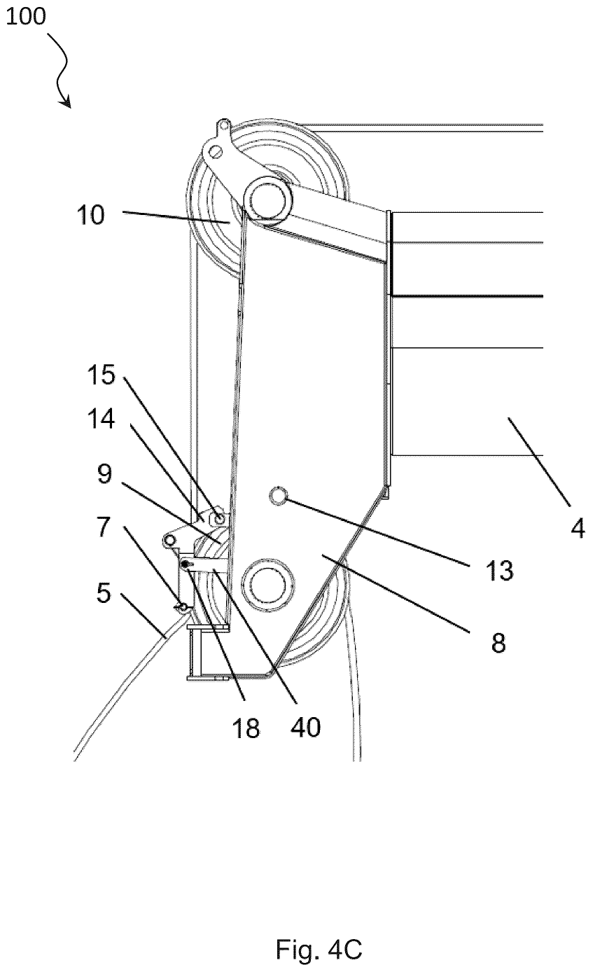

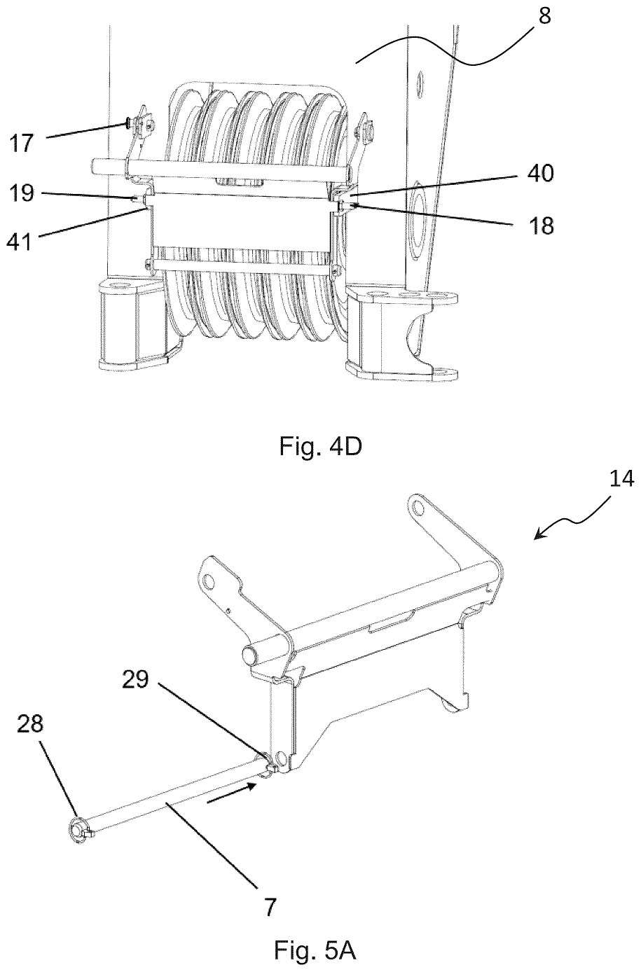

FIG. 4A is a perspective view of a cable securing arrangement 14 according to the disclosure, which is to be pivotably arranged on a pulley head 8. Said cable securing arrangement has a first limb element 21 and a second limb element 23, which each comprise an opening which serves for implementing an attachment to the pulley head 8. In this case, the two limb elements 21, 23 are spaced apart from one another in the pulley rotational axis and are interconnected via a cable protection bar 7 extending in parallel with the pulley rotational axis. In order to ensure simple operability of the cable securing arrangement 14, a grip element 12 extending in the pulley rotational axis can also be provided, which grip element interconnects the two limb elements 21, 23.

Furthermore, the blocking element 32, which can optionally be provided, is also shown, which element also extends between the two limb elements 21, 23, and the significance of which will be explained in more detail in the further course of the description of the figures. It can be seen, however, that a stop element 20, 33 protrudes from the blocking element 32, in each case in the direction of the pulley rotational axis, which stop element serves for correct positioning of the cable securing arrangement 14 in the securing position. The stops 34, 35 then come together with a component of the pulley head 8, when the cable securing arrangement 14 has reached the release position.

The dashed line 25 symbolises the course of a position of a preloadable locking element arranged on the pulley head 8, as said element is pushed back or tensioned by a curved portion 231 on the limb element, upon transfer of the cable securing arrangement 14 into the securing position, such that it snaps into the opening 24, after reaching the securing position, owing to the spring preload generated by the curved portion 231.

Analogously thereto, the dashed line 22 symbolises the course of a position of a preloadable locking element arranged on the pulley head 8, as said element pushes against the first limb element 21 with a certain force generated by the preload, upon transfer of the cable securing arrangement 14 into the release position, such that it snaps into the opening 28, after reaching the release position, owing to the preload, and fixes the cable securing arrangement 14 in the release position.

As is clear in conjunction with the following figures, the deflection device 100 is accordingly constructed in such a way that the securing arrangement 14 can be brought into the open position, or release position, by a rotational movement about the pivot axis 15. In this case, for example a latching bolt 17 extends over the limb element 21 along the curve 22 of the cable securing arrangement 14, until it latches into the opening 28. This locking can take place automatically by the spring return of the latching bolt 17, as a result of which the cable securing arrangement 14 is secured in the open position without additional mounting effort.

FIG. 4B is a side view of the deflection device 100 with a cable securing arrangement 14 in the open position, or release position. In this position, the cable securing arrangement 14 is rotated about the pivot axis 15 extending in parallel with the pulley rotational axis, as a result of which the lifting cable 5 can be securely reeved. During the reeving process, the lifting cable 5 extends along the reeving curve 16 (shown in dashed lines) and is guided via the cable pulleys 9 to the hook block 6. It can be seen that the cable protection bar 7 of the cable securing arrangement 14 is not located in a region between the reeving curve 16 and the outer periphery of the cable deflection pulley 9, due to the pivoting into the release position, such that there is no longer the risk, in the case of a reeving process, of the cable to be reeved being guided along on the side of the cable protection bar 7 remote from the cable deflection pulley 9.

In this case, a reeving curve refers to the position of a cable start during a reeving process. In this case, it can optionally be provided that the reeving curve is set for one side of the cable pulley, by a substantially horizontal feed onto an upper point of a cable deflection pulley, and the cable start guided over the upper point of the cable deflection pulley is identified by further feeding of cable length.

It should be noted that, for frictionless reeving, the second cable protection bar 13, which may possibly be present and is arranged in the upper region of the cable deflection pulley 9, must also be removed.

A receiving element 40 protruding forwards from the pulley head 8 is provided for locking the cable securing arrangement 14 in its securing position, which receiving element has a preloadable latching pin 18 on its end remote from the pulley head 8, which pin can interact with a corresponding detent opening 24 on one of the two limb elements of the securing arrangement 14, in order to enter a latching connection in the case of a transfer of the securing arrangement 14 into the securing position. A similarly acting locking device is also provided for holding the securing arrangement 14 in the release position.

FIG. 4C is a side view of the deflection device 100 with the cable securing arrangement 14 in the closed position, or securing position. In this position, the cable securing arrangement 14 is oriented in such a way that the lifting cable 5 is secured against springing out from at least one cable deflection pulley 9. The cable securing arrangement 14 is locked by the latching bolt 18, which, in the closed position, is guided along the curved portion 231 on the limb element 23 and the curve 25 until it latches into the opening 24. This locking ensures that the lifting cable 5 is pressed sufficiently close to the cable pulleys 9, as a result of which stable and reliable guidance of the cable 5 is ensured.

The construction of the cable securing arrangement 14 in combination with the latching bolts 18, 19 furthermore ensures that the lifting cable 5 no longer-as is conventional according to the prior art-has to be pressed with direct hand contact onto the cable grooves of the cable pulleys 9, in order to allow for mounting of the cable protection bar, but rather this takes place automatically by the contact with the cable securing arrangement 14 upon transfer into the securing position.

FIG. 4D is a perspective view of the lower part of the pulley head 8, with a cable securing arrangement 14 in the closed state. In this case, the latching pin 17 is also visible, which pin ensures locking of the cable securing arrangement 14 in the release position in that it interacts with the opening 26 (shown e.g. in FIG. 4A).

It can furthermore be seen that, for securely fastening the securing arrangement 14 in the securing position, an opening is present on each of the two limbs 21, 23, which opening interacts with a locking device fastened on the pulley head 8, via a receiving element 40. The latching pin 19 on the receiving element 41 is visible on the side shown on the left in FIG. 4D, and the latching pin 18 on a receiving element 40 is visible on the side shown on the right, which elements are each fastened on the pulley head 8.

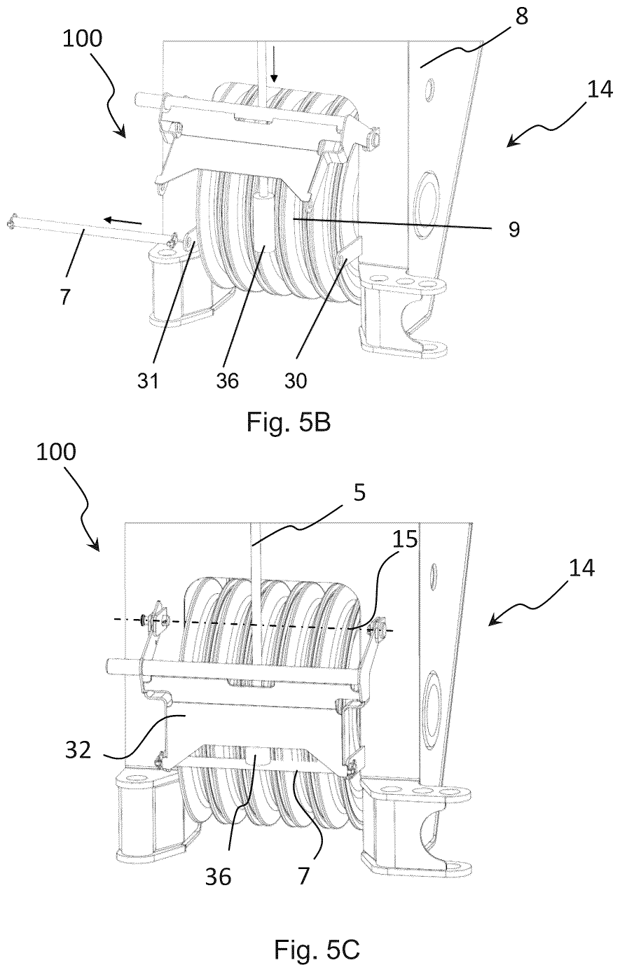

FIG. 5A shows a second embodiment of the present disclosure, wherein in this embodiment the essential principle of the pivoting of the cable securing arrangement is retained, but with different implementation of the locking with respect to the pulley head in the securing position. Thus, the locking of the cable securing arrangement 14 takes place with the aid of the cable protection bar 7 and openings in the distal region of the respective limb elements, through which the cable protection bar 7 can be inserted. In order to ensure that the cable protection bar 7 remains securely, said bar can comprise linchpins 28, 29 at its respective longitudinal end regions, which linchpins ensure a secure hold after passing through the openings of the cable securing arrangement 14.

FIG. 5B illustrates the deflection device 100 according to the second embodiment, in which the securing arrangement 14 is in its open position. As already explained, the cable protection bar 7 is used for locking in the securing position. In the open position, the release position, the cable protection bar 7 is dismantled, as a result of which the cable securing arrangement 14 can be moved into the release position, in order to reeve the lifting cable 5 along the defined reeving curve 16.

The cable securing arrangement 14 is brought into the open position by the rotational movement about the pivot axis 15. The linchpins 28 and 29 have to be removed beforehand, in order to be able to pull the cable protection bar 7 laterally out of the openings of the receiving elements 30, 31 arranged to the left and right of the pulley package, on the pulley head 8. After the cable protection bar 7 has been dismantled, the cable securing arrangement 14 can be moved upwards into the open position, without the guided-out cable protection bar 7, about the pivot axis 15. The latching bolt 17 already described with reference to the above embodiment then automatically locks the cable securing arrangement 14 in the release position.

In this way, there is now sufficient space in the radial direction of the cable deflection pulley 9 to be able to guide the cable start, for example the closure spelter socket 36 shown in FIG. 5B, downwards for correct reeving.

FIG. 5C is a perspective view of the deflection device 14 in the second embodiment, in the securing position. Compared with FIG. 5B, discussed above, it can be seen that it is not possible to guide through a cable start with the closure spelter socket 36 that is typically arranged on the cable start, since the blocking element 32 prevents direct guidance along the outside of the cable protection bar 7. In this case, the illustrated space between the cable protection bar 7 and the blocking element 32 is dimensioned in such a way that the closure spelter socket 36 does not pass through.

The deflection device according to the second embodiment with the illustrated cable securing arrangement 14 furthermore allows for simpler retrofitting ability on the existing pulley head 8, since it uses the pre-existing receptacles 30 and 31 and is compatible with the same pre-mounting parts as the cable protection bar 7 and the linchpins 28 and 29, which are used in implementations according to the prior art.

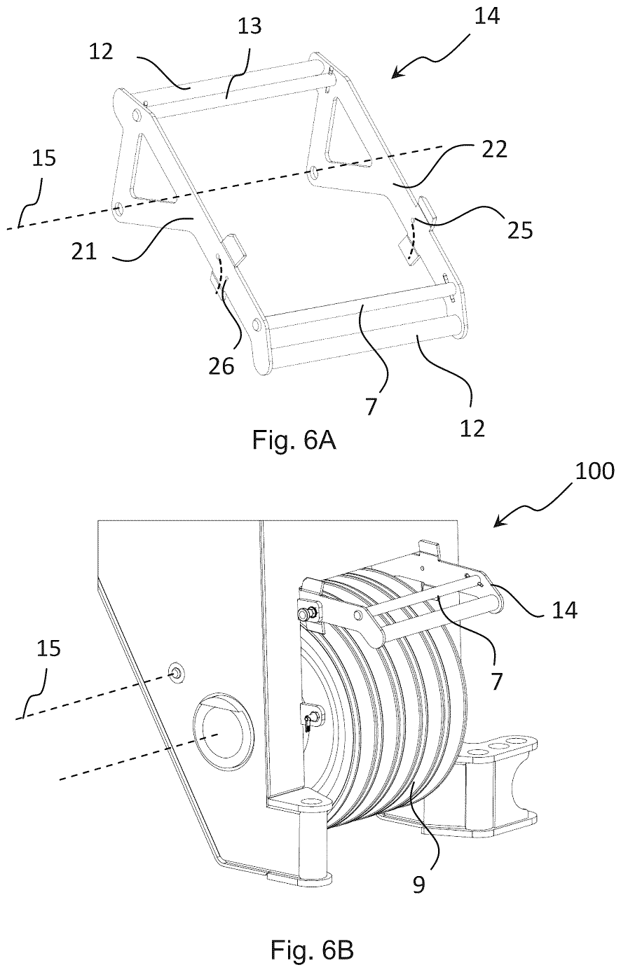

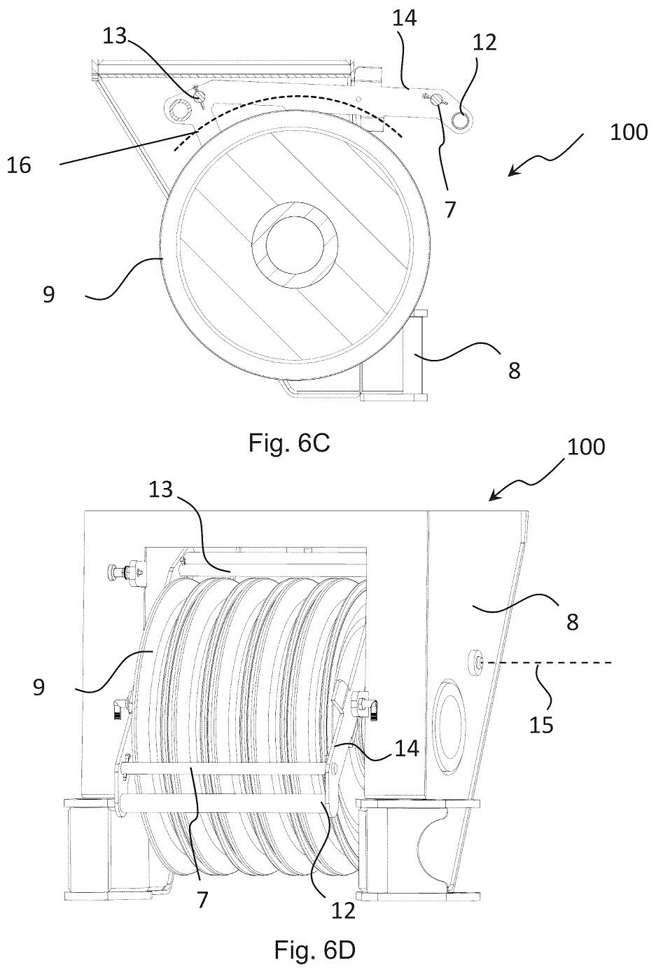

FIG. 6A is a perspective view of a third embodiment of the deflection device 100, wherein the cable securing arrangement 14 not only contains the cable protection bar 7 but rather also the second cable protection bar 13, which is typically to be positioned in the vicinity of the upper point of a cable deflection pulley 9 received in the pulley head 8.

Similarly to the first cable protection bar 7, the second cable protection bar 13 also extends from one limb element to the other limb element, in parallel with the pulley rotational axis or the pivot axis 15. An advantage of this is that it is now possible for both the first cable protection bar 7 and the second cable protection bar 13 to be moved into a position with just one movement, specifically the pivoting of the cable securing arrangement 14 of the deflection device 100 according to the third embodiment, such that in the case of a reeving process the likelihood of incorrect reeving can be entirely excluded or at least significantly reduced.

It can furthermore also be seen that the opening 25 is now no longer used only for locking in one of the two positions, the release position and the securing position, but rather for both. In order, in this case, to allow for preloading of the latching pin for each of the two movements for transfer into the release position or the securing position, the limb element has a correspondingly configured curved portion, which can push back both the latching pin in the release position and the latching pin in the securing position, such that when the latching pin is flush with the opening 26 the latching pin snaps in and the cable securing arrangement 14 is locked in the corresponding position.

In order to retain sufficient stability of the cable securing arrangement 14 even if both cable protection bars 7, 13 are removed, for example in order to replace them, in the context of maintenance, a further stabilising element 27 can be provided in addition to the grip-like holder 12, which stabilising element optionally interconnects the two limb elements 21, 23 in the region of the second cable protection bar 13. In this case, the stabilising element 27 also assumes a blocking function.

FIG. 6B shows the deflection device 100 with its cable securing arrangement 14 in the release position. In order to reach the open position, the cable securing arrangement 14 is moved upwards by a rotational movement about the pivot axis 15, wherein the cable protection bars 7 and 13 are brought simultaneously into the open position. This facilitates the process of reeving, since it is now no longer necessary for either of the two cable protection bars 7, 13 to be dismantled from the pulley head 8. The pulley rotational axis is also symbolised, in parallel with the pivot axis 15, by a dashed line.

FIG. 6C is a sectional view from the side, in which the cable securing arrangement 14 is in its release position. In this case, it can be seen that neither the first cable protection bar 7 nor the second cable protection bar 13 collide with the reeving curve 16, but rather the reeving curve 16 extends between the respective cable protection bars 7, 13 and the radial outer periphery of the cable deflection pulley 9. This means that, in the case of a normal reeving process, the respective cable protection bars 7, 13 do not collide with the cable to be reeved or the closure spelter socket arranged on the start of the cable to be reeved, such that a normal reeving process can be carried out. An advantage of this is that the cable securing arrangement 14 ensures, by means of one single pivot movement, that both cable protection bars 7, 13 are transferred out of their securing position into their respective release position. Accordingly, it is no longer necessary to perform separate work processes in order to dismantle the two cable protection bars 7, 13, in order to be able to carry out a reeving process.

In this case, a significant advantage for the reeving process is the omission of loose parts that can be dismantled, such that it is no longer possible for forgotten parts to fall down from high lifting heights. This source of risk is also eliminated by this embodiment.

FIG. 6D shows the deflection device 100 in its closed position. In this position, the cable securing arrangement 14 is oriented in such a way that the lifting cable 5 is runs securely in the cable pulleys 9 and is secured against springing out (wherein there is no contact between the rod and pulleys). In this case, the cable securing arrangement 14 is automatically locked after the release position and/or the securing position has been reached, since here, too, at least one latching bolt penetrates into an opening of a limb element when the corresponding position has been reached.

### LIST OF REFERENCE SIGNS

1 work machine
2 undercarriage
3 upper structure
4 telescopic boom
5 lifting cable
6 hook block
7 cable protection bar
8 pulley head
9 cable deflection pulley (lower pulley package)
10 cable deflection pulley (upper pulley package)
11 boom head
12 grip element
13 second cable protection bar
14 cable securing arrangement
15 pivot axis
16 reeving curve
17 latching pin
18 latching bolt
19 latching bolt
20 stop element
21 first limb element
22 curve
23 second limb element
24 opening
25 opening
26 opening
27 stabilising element
28 linchpin
29 linchpin
30 receiving element
31 receiving element
32 blocking element
33 stop element
34 stops
35 stops
36 closure spelter socket
40 receiving element
41 receiving element
100 deflection device
231 curved portion

1. A deflection device for a cable, comprising:
a pulley mounting for carrying at least one cable deflection pulley,
at least one cable deflection pulley, which is mounted on the pulley mounting so as to be rotatable about a pulley rotational axis, and
a cable securing arrangement for securing a correct reeving of the cable on the cable deflection pulley,
wherein the cable securing arrangement is pivotable relative to the pulley mounting about a pivot axis, in order to switch between a securing position, in which a cable deflected by the cable deflection pulley is secured in the cable deflection pulley, and a release position, in which a cable deflected by the cable deflection pulley is not secured in the cable deflection pulley, and
wherein the pivot axis extends in parallel with the pulley rotational axis.

2. The deflection device according to claim 1, wherein the cable securing arrangement comprises at least one cable protection bar, which is configured, in the securing position of the cable securing arrangement, to limit a movement of the cable, guided by the cable deflection pulley, in the radial direction away from the cable deflection pulley.

3. The deflection device according to claim 2, wherein the at least one cable protection bar assumes a greater radial spacing from the at least one cable deflection pulley in the release position than in the securing position, in order to allow for correct reeving of the cable on the at least one cable deflection pulley, in which the cable to be reeved is arranged between the at least one cable deflection pulley and the at least one cable protection bar.

4. The deflection device according to claim 1, wherein the pivot axis is arranged, relative to the pulley rotational axis, so as to be radially offset with respect to the at least one cable deflection pulley.

5. The deflection device according to claim 2, wherein the cable securing arrangement comprises two limb elements, which are rotatably fastened on opposing side parts of a receiving space of the pulley mounting for receiving the at least one cable deflection pulley.

6. The deflection device according to claim 5, wherein the at least one cable protection bar is mounted at its respective longitudinal end regions on the two limb elements, and is oriented in parallel with the pulley rotational axis.

7. The deflection device according to claim 5, wherein a blocking element extends between the two limb elements, in the direction of the pulley rotational axis, which blocking element serves to make it more difficult to guide through the cable, deflected by the cable deflection pulley, on a side facing away from the cable securing arrangement to the at least one cable deflection pulley.

8. The deflection device according to claim 5, further comprising a grip element.

9. The deflection device according to claim 1, further comprising at least one locking device for locking the cable securing arrangement in the securing position and/or the release position, on the pulley mounting.

10. The deflection device according to claim 9, wherein the at least one locking device comprises a detent opening and an associated detent, wherein in each case one component of the locking device is arranged on the cable securing arrangement and the other component is arranged on the pulley mounting.

11. The deflection device according to claim 9, wherein, in the securing position, the locking device comprises:
a cable protection bar configured to limit a movement of the cable, guided by the cable deflection pulley, in the radial direction away from the cable deflection pulley, and
receiving openings for the cable protection bar, arranged on opposing side parts of a receiving space of the pulley mounting, such that the securing position can be left only after the cable protection bar has been released from the receiving openings.

12. The deflection device according to claim 1, wherein at least two cable protection bars are provided, which act on different radial regions of the at least one cable deflection pulley and the respective active regions of the two cable protection bars in the peripheral direction of the cable deflection pulley enclose an angle relative to one another that exceeds 60°.

13. A system comprising the deflection device according to claim 1 and a cable, wherein the dimensioning of the cable is matched to the at least one cable deflection pulley and is deflected thereby.

14. A lifting device, comprising the deflection device according to claim 1.

15. The lifting device according to claim 14, wherein the deflection device is arranged on a boom head of a boom.

16. The deflection device according to claim 2, wherein the at least one cable protection bar is oriented having its longitudinal axis in parallel with the pulley rotational axis, and/or is mounted so as to be rotatable about its longitudinal axis.

17. The deflection device according to claim 3, wherein the at least one cable protection bar is radially further removed from the at least one cable deflection pulley, in the release position and when the deflection device is oriented as intended, than a reeving curve of a cable to be reeved, the dimensioning of which is matched to the at least one cable deflection pulley.

18. The deflection device according to claim 5, wherein the two limb elements are rotatably fastened in such a way that the rotatable fastening of the two limb elements represents the pivot axis of the cable securing arrangement.

19. The deflection device according to claim 18, wherein the two limb elements are configured identically to one another.

20. The deflection device according to claim 7, wherein the blocking element extends in such a way that an opening region between the blocking element and a cable protection bar does not allow for a cable, or its cable spelter socket located at the cable start thereof, the dimensions of which cable are matched to the at least one cable deflection pulley, to be guided through.
